(19) United States
(12) Patent Application Publication
(10) Pub. No.: US 2023/0081223 A1
(43) Pub. Date: Mar. 16, 2023

(54) Space Heater

(71) Applicant: Vornado Air, LLC, Andover, KS (US)

(72) Inventors: Gregory Pease, Andover, KS (US); Byron Loibl, Wichita, KS (US); Brian M. Cartwright, Wichita, KS (US); Cooper Phillips, Wichita, KS (US); Samuel Parduhn, Wichita, KS (US)

(21) Appl. No.: 17/947,063

(22) Filed: Sep. 16, 2022

Related U.S. Application Data
(60) Provisional application No. 63/245,195, filed on Sep. 16, 2021.

(51) Int. Cl. F24H 3/04; H05B 3/16

(52) U.S. Cl. CPC F24H 3/0417; H05B 3/16; F24H 2250/02

(57) ABSTRACT

A portable space heater is provided having a heating assembly that includes at least one heating element positioned in front of a fan (defined by the direction of the air flow with the air blowing toward the front) such that the heating element is in linear alignment with the fan along the axis of rotation of the fan. The fan and the at least one heating element may be further positioned within a duct assembly that narrows as it approaches a front grill of the portable space heater.

### CROSS-REFERENCE TO RELATED APPLICATIONS

This application claims priority to U.S. Provisional Patent Application Ser. No. 63/245,195, having a filing date of Sep. 16, 2021 and titled Heater Assembly, which application is incorporated into this application in its entirety.

### FIELD OF INVENTION

The invention relates to a heater, and in particular a heating assembly having a fan positioned directly behind the heating elements of the heating assembly to direct airflow across and through the heating elements.

### BACKGROUND

Space heaters for heating air are well known in the art, and are usually sold as portable, free-standing units. Space heaters may include many types of heating elements, such as heating coils, ceramic heaters, and/or PCT heaters, to name a few. Space heaters often use blowers or fans to push or pull air, once heated, out of a heating chamber. Most personal space heaters, and in particular fan heaters, having open grills on both the front and back of the heater, place heating elements in the back of the space heater and use a fan to draw air in from the back of the heater, across the heating elements, and then push the hot air out the front of the grill with the fan positioned in the front of the heating element(s) relative to the direction of the air flow.

Portable electric space heaters continue to have problems with distributing heat over large areas. Accordingly, a need still exists for a compact, portable electric space heater that is capable of both increased air velocity and increased temperature outputs over those in the prior art.

### SUMMARY OF THE INVENTION

A portable space heater is provided having a heating assembly that includes at least one heating element positioned in front of a fan (defined by the direction of the air flow with the air blowing toward the front) such that the heating element is in linear alignment with the fan along the axis of rotation of the fan. The fan and the at least one heating element may be further positioned within a duct assembly that narrows as it approaches a front grill of the portable space heater.

In one example, a space heater is provided that includes a heater housing having a front grill and rear grill; a fan positioned near the rear grill of the heater housing; at least one heating element positioned in front of the fan behind the front grill of the heater housing where the heating element and the fan are linearly aligned; and a duct assembly positioned within the heater housing surrounding both the fan and the heating element where the duct assembly gradually decreases in circumference as it approaches the front grill of the heater housing.

In another example, the space heater may include a heater housing having a front grill and rear grill and a heating assembly. The heater assembly includes a fan having at least two fan blades having fronts and tips and at least one circular heating element positioned in front of the fan where the center of the circular heating element is on the axis of rotation of the fan and where the diameter of the circular heating element extends across the fronts of the fan blades not beyond the tips of the fan blades. The heating assembly is further positioned within the heater housing such that the heating element is behind the front grill of the heater housing and the fan is near the rear grill of the heater housing.

In yet another example, the space heater may include a heater housing having a front grill and rear grill and a heating assembly. Here, the heater assembly may include a fan having a fan hub and fan blades, where the fan blades have fronts and tips and at least one ring shaped heating element positioned in front of the fan where the center of the ring shaped heating element is on the axis of rotation of the fan and where the ring shaped heating element is in linear alignment with the fan such that the at least one ring shaped heating element is positioned between the hub of the fan and the tip of the fan blades. Again, the heating assembly is positioned within the heater housing such that the heating element is behind the front grill of the heater housing and the fan is near the rear grill of the heater housing.

In all the examples above, the heating elements may include one or more ring shaped heating elements, and fan may include a fan hub and two or more fan blades each having fronts and tips. The one or more ring shaped heating element may be positioned in front of the fan where the center of the one or more ring shaped heating elements is on the axis of rotation of the fan and is in linear axial alignment with the fan such that the one or more ring shaped heating elements are aligned between a hub of the fan and the tips of the fan blades. In certain examples, at least two ring shaped heating elements are included. The ring shaped heating elements may take the form of a heating ribbon, which heating ribbon may include ceramic heating elements, coil heating elements or wire heating elements. The ring shaped heating element may further be wire coil or other heating elements generally known in the art.

In all examples, the fan and the at least one heating element may be in communication with a controller that is programed to operate the fan either with, or independent of, the at least one heating element.

In all examples that include a heating assembly, the heater housing may further include a duct assembly positioned within the heater housing enclosing the heating assembly where the duct assembly gradually decreases in circumference as it approaches the front grill of the heater housing.

In all examples, the space heater may further include a motor having a shaft positioned between the at least one heating element and the fan, where the fan is affixed to the shaft of the motor and where the at least one heating element is mounted to the motor on the side of the motor opposing the shaft. The at least one heating element may further be affixed to a barrel mount, where the barrel mount is mounted to the motor.

In the above examples, with the fan positioned behind one or more heating elements, the fan pushes air across the one or more heating elements and out the front of the space heater. This configuration allows the heat produced by the coils to move faster and travel farther than other known prior art personal heaters. In this arrangement, the fan can also be operated separate from the one or more heating elements to enable a fan only option. When more than one heating element is used, the heating elements can be operated together or independently to vary heat production and/or may be operated at different levels.

As described in further detail below, the fan blades may further be designed, as illustrated in FIGS. 8 and 9, to maximize the movement of the air across the one or more heating elements and allow the heat to travel farther and more effectively and efficiently. The blade tips and blade angles are also positioned to maximize air flow through and across the heating elements, as shown and illustrated. For example, the fan may include wing tipped fan blades, the blades may be angled relation to the axis of rotation of the fan and the distal ends of the fan blades may be bent inward toward the direction of air flow of the fan.

Other devices, apparatus, systems, methods, features and advantages of the invention are or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF FIGURES

The invention may be better understood by referring to the following figures. The components in the figures are not necessarily to scale, emphasis instead being placed upon illustrating the principles of the invention.

FIG. 1 is one example of a front perspective view of a portable space heater using a heating assembly of the presenting invention.

FIG. 2 is a rear perspective view of a portable space heater of FIG. 1.

FIG. 3 is an exploded view of the portable space heater of FIG. 1.

FIG. 4 is one example of a front elevation view of the heating assembly of the present invention.

FIG. 5 is a side perspective view of the heating assembly of FIG. 4.

FIG. 6 is a side view of the heating assembly of FIG. 4.

FIG. 7 is a rear view of the heating assembly of FIG. 4.

FIG. 8 is a front perspective view of the fan of the heating assembly of FIG. 4.

FIG. 9 is a top view of the fan of the heating assembly of FIG. 4.

FIG. 10 is a front perspective side view of one example of a duct assembly of portable space heater of FIG. 1.

FIG. 11 is a rear perspective side view of the duct assembly of FIG. 10.

FIG. 12 is a side view of the duct assembly of FIG. 10.

### DETAILED DESCRIPTION OF THE INVENTION

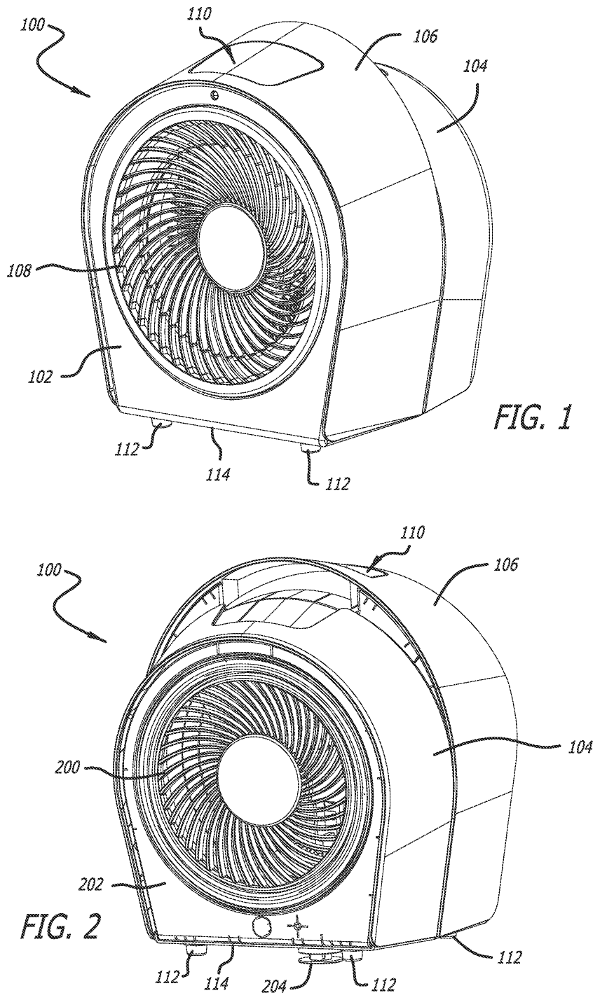

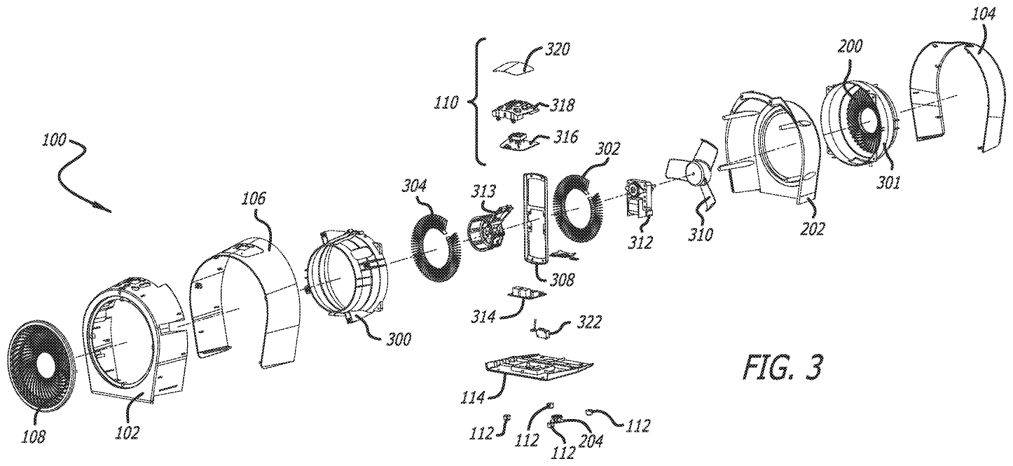

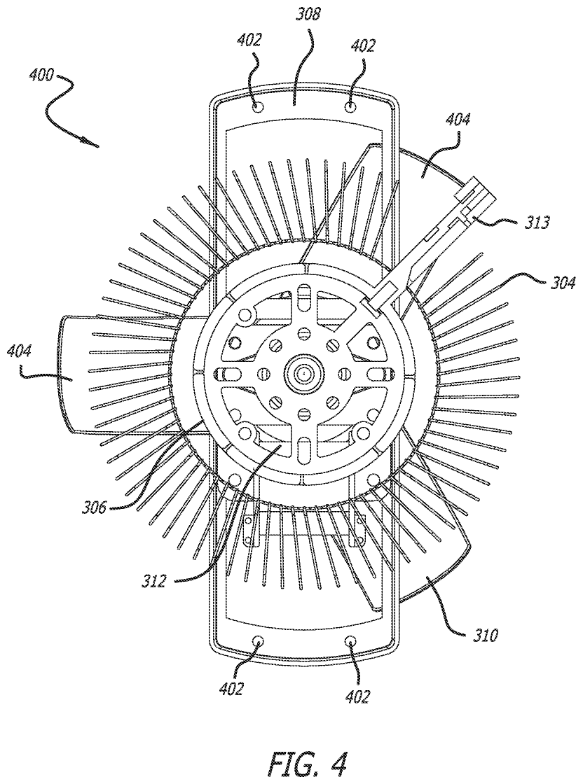

As illustrated in the attached FIGS. 1-12, a heating assembly is provided for use in connection with a portable space heater. As will be explained further below, the heating assembly 400 (FIG. 4) includes dual heating elements 302, 304 having a fan 310 (FIG. 3) positioned directly behind dual heating elements. The fan 310 can be operated independent of, or in conjunction with, the heating elements 302, 304. As such, the portable space heater 100 illustrated in FIG. 1-12 is often referred to as a fan heater. For purposes of this application, terms fan heater and portable space heater may be used interchangeably without departing from the scope of the invention.

In the context of this application, when the fan 310 is described as being “directly” behind the heating elements 302, 304 or the heating elements 302, 304 “directly” in front of the fan 310, it means that while there can be intermediary parts positioned between the fan 301 and the heating elements 302, 304, there should be nothing between the fan 310 and the heating elements 302, 304 to substantially obstruct or redirect the air flow from the fan 310 to the heating elements 302, 304. In other words, the fan 310 should be permitted to blow air directly on to the heating elements 302, 304. The positioning of mounting brackets or other mechanisms of attachment between the elements does not change one being deemed directly in front of the another.

FIG. 1 is one example of a front perspective view of a portable space heater 100 using a heating assembly 400 (FIG. 4) of the presenting invention. FIG. 2 illustrates a rear perspective view of the portable space heater 100 of FIG. 1. As illustrated in FIGS. 1 & 2, the portable space heater 100 is provided having a front housing 102 and a rear housing 202. In this example, the front housing 102 further includes a front cover 106 and the rear housing 202 further includes a rear cover 104, both the front and rear cover 106, 104 are positioned over the front and rear housings 102, 202 to cover internal features that may be considered aesthetically undesirable. Those skilled in the art will recognize that the front housing 102 and front cover 106 may alternatively be a single piece. Similarly, the rear housing 202 and a rear cover 104 may also alternatively be a single piece without departing from the scope of the invention. Further, it should be understood that the front housing 102 and front cover 106, as well as the rear housing 102 and rear cover 104 may be of any ornamental design and are not limited to the ornamental designs illustrated in FIGS. 1 & 2.

The front housing 102 further includes a front grill (or vent) 108 and a control panel 110. The rear housing 202 further includes a rear grill (or vent) 200. The portable space heater 100 is supported at its base 114 by supports 112, which includes a pressure switch 204 that triggers an anti-tilt switch 322 that automatically shut off the portable space heater 100 in the event the portable space heater 100 is tipped over.

FIG. 3 is an exploded view of the portable space heater of FIG. 1. FIG. 3 illustrates the front housing 102 having a front grill 108 and front cover 106. The rear housing 202 and rear grill 200, along with the rear top cover 104 are illustrated in FIG. 3. The heater base 114, supports 112 and the pressure switch 204 are also shown below the base 114 of the portable space heater 100, with the anti-tilt switch 322 shown above, which connects to the pressure switch 204 and shuts off the operation of the portable space heater 100 in the event the unit is tilted, lifted, or tipped over.

The internals of the portable space heater 100 are best shown in FIG. 3. Housed within the front and rear housing 102, 202 is a duct assembly 900 (FIG. 9) that includes a front duct 300 and rear duct 301, which directs the airflow from the rear grill 200 of the portable space heater 100 to the front grill 108. Contained within the front duct 300 and rear duct 301 is a heating assembly 400 (FIG. 4) that includes one or more heating elements. In this example, the heating assembly 400 includes a first and second heating element 302, 304, a barrel mount 306, a fan 310 and a motor 312, all of which are supported by mounting bracket 308 which mounts onto the front duct 300.

The portable space heater 100 further includes a printed circuit board (“PCB”) 314 having integrated circuit(s), a processor and/or controller is provided that is in communication with a power source (not shown). The first PCB 314 is also in communication with the motor 312 and first and second heating elements 302, 304 to control the operation of the motor 312 and first and second heating elements 302, 304. A second PCB 316 having an integrated circuit(s), controller and/or processor is also provided for the control panel 110, which includes, in addition to the second PCB 314, an LCD display, circuit board cover 318 with user controls and a protective cover 320.

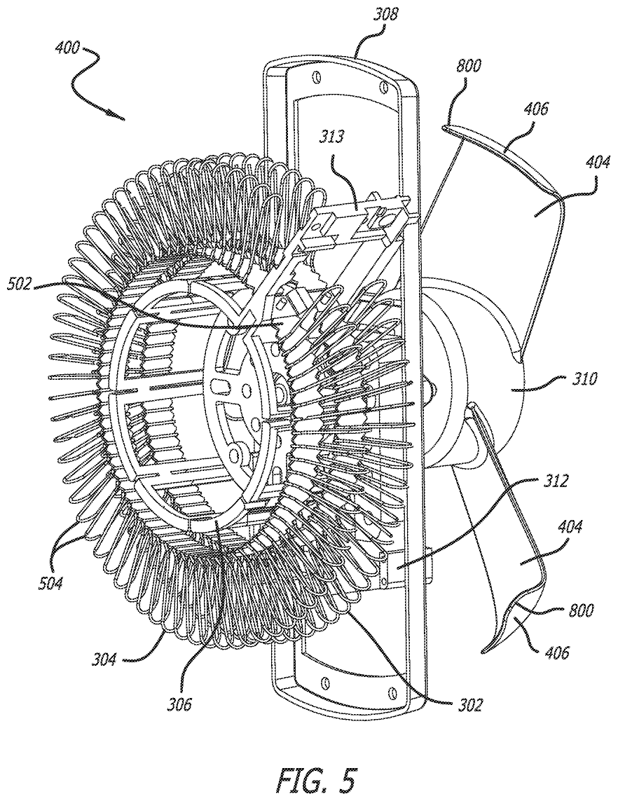

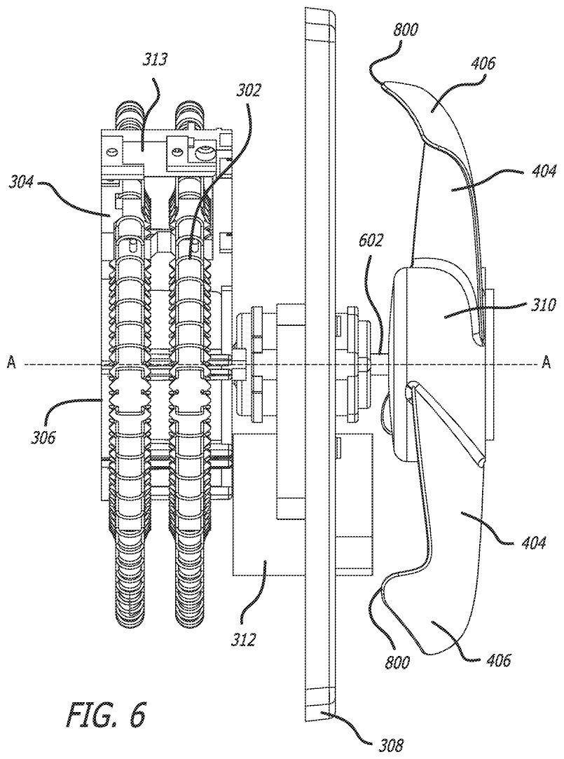

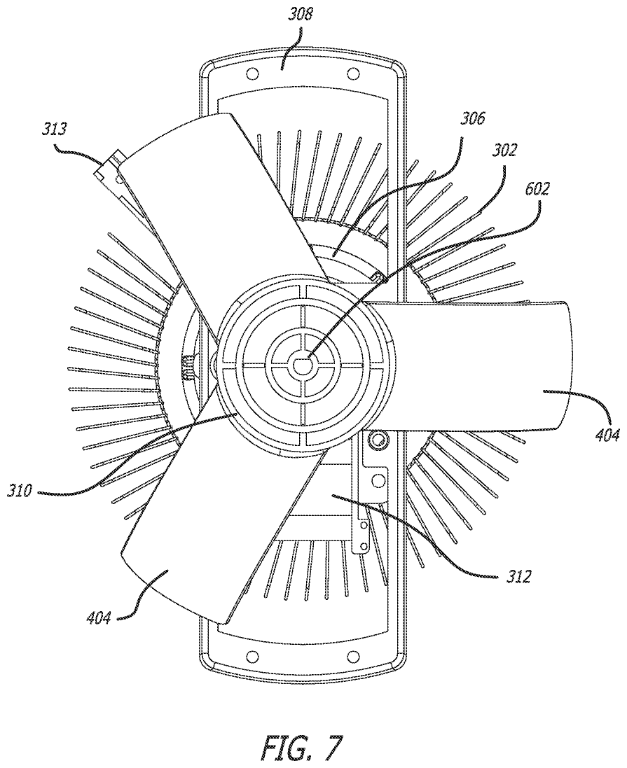

Next we turn to a discussion of the heating assembly 400 contained within the front duct 300 and rear duct 301 of the front and rear housing 102, 202 of the portable space heater 100. FIGS. 4-7 all illustrate one example of the heating assembly 400 of the portable space heater 100. FIG. 4 is a front elevation view of the heating assembly 400, FIG. 5 is a side perspective view of the heating assembly 400, FIG. 6 is a side view of the heating assembly 400, and FIG. 7 is a rear view of the heating assembly 400. The elements that comprise the heating assembly 400 and their respective spatial relationship to one another are best understood by viewing and describing FIGS. 4-7 together, with reference to FIG. 3.

For purposes of reference and description, the heating assembly 400 is considered to have an assembly axis, which is represented by line A-A of (FIG. 6) along which the components of the heating assembly 400 are positioned relative to each other, and which axis is also the rotational axis of the fan 310 and which assembly axis also runs the length of the portable space heater 100 from the front grill 108 to the back grill 200.

Terms such as “axial” and “axially” are assumed to refer to the assembly axis or any direction or axis parallel to the assembly axis, unless indicated otherwise or the context dictates otherwise. In this disclosure, the plane orthogonal to the assembly axis is referred to as the transverse plane. For convenience, movement relative to the assembly axis may alternatively encompass movement relative to an axis that is parallel to the assembly axis that is specifically illustrated in FIG. 6, unless the context dictates otherwise. Thus, linear translation “along the assembly axis” is not limited to translation directly on (coincident with) the assembly axis, but also encompasses translation parallel to the assembly axis, depending on the context. Similarly, rotation “about the assembly axis” also encompasses rotation about an axis that is parallel to the assembly axis, depending on the context.

In one example, the assembly axis may be oriented at an angle perpendicular to, or at an obtuse (more than 90 degree) angle relative to, a ground surface on which portable space heater is disposed or is intended to be disposed (e.g., a tabletop, desktop, shelf, floor, etc.). From the perspective of FIG. 1, the ground surface corresponds to a generally horizontal plane passing orthogonally through the drawing sheet.

The heating assembly 400 includes one or more heating elements, which in this example are heating elements 302, 304, and which are positioned directly behind the front grill 108 of the portable space heater 100. The heating elements 302, 304 are mounted on the exterior of a circular barrel mount 306, the center of which is aligned about the assembly axis. The barrel mount 306 has a terminal box 313 for electrically connecting the heating elements 302, 304 to a power supply (not shown) through the first PCB 314. The motor 312 is interposed between one side of the barrel mount 306 and the fan 310. The barrel mount 306 is mounted on a first side of the motor 312. Directly opposing its first side of the motor 600 is a shaft 602 upon which the fan 310 mounted. Operation of the motor 312 rotates the shaft 602, which rotates the fan 310.

The motor 312, having both the barrel mount 306 and fan 310 affixed thereto, is secured to the mounting bracket 308, which is mounted on its ends through holes 402 on the first duct 300 (FIG. 300) such that mounting bracket 308 is positioned between the first and second ducts 300, 301 when secured together. In this manner, the heating assembly 400 is encased with the first and second ducts 300, 301 with the barrel mount 306 and heating elements 302, 304 in the front duct 300 and the fan 310 in the rear duct 301, with the motor 312 generally centered between the first and second ducts 300, 301.

The motor 312 and heating elements 302, 304 are electrically connected and in communication with the first PCB 314 to control and provide power to the heating elements 302, 304, motor 312, and conversely the fan 310.

As best illustrated in FIG. 5, the heating elements 302 and 304 are two concentric rings mounted on the exterior of the barrel mount 306. Each heating element 302 and 304 include a ring formed of a heating ribbon 502 having a plurality of evenly spaced U-shaped wire heating elements 504 connected thereto and extending upward from the heating ribbon 502 about the circumference of the heating ribbon 502. The heating ribbon 502 includes a first end and second end each connected on opposite sides of the terminal box 313. The plurality of wire heating elements 504 on each heating element 302 and 304 extend around the circumference of the heating ribbon 502 commencing on one side of the terminal box 313 and terminate on the other side of the terminal box 313. Electrical connections are made on the terminal box 313 to power the heating elements 302, 304 through connection to the first PCB 314.

As illustrated in FIGS. 4-7, the fan 310 is placed directly behind the heating elements 302, 304. The fan blades 404 of the fan 310 are positioned in angled relation to the rotational axis of the fan, which is shown as the assembly axis and line A-A (FIG. 6). The distal end 406 of each fan blade 404 is bent forward and with the angled orientation of the blade 404 creates a wing tip 800 on each fan blade 404.

The axis of rotation of the fan 310 runs through the center point of each heating element 302 and 304 defined by the center of the concentric rings of the heating element 302, 304. The diameter across the concentric rings of the heating element 302 and 304, along with the height of the U-shaped wire heating elements 504 is design to position the U-shaped wire heating elements 504 in linear alignment with the front face of the fan blades 404 across the assembly axis.

Further, in the illustrated example, the U-shaped wire heating elements 504 do not extend past the tips 800 of the fan blades 404, but rather extend only to the point just prior to where the fan blades 404 start to bend forward. Accordingly, the heating elements 302, 304 are in linear alignment with the fan blades 404 across the rotational axis of the fan 310, such that the heating elements 302, 304 are positioned directly in front of the fan blades between the hub 802 of the fan 310 and the bend 406 of the distal end of the fan blade 404. In other words, the heating elements 302, 304 are linearly aligned with the fan blades 404 between the hub 802 of the fan 310 and the tip of the fan blade 800 or, more particularly, between the hub 802 of the fan 310 or the bend 406 on the fan blade 800 at its distal end. As designed, air flow produced by the fan is directed through and across the heating elements 302, 304.

Alternatively, the diameter of the heating elements 300, 302 may be equal to or lesser than the fan 310 diameter, such that the heating elements 300, 302 are positioned at or just inside the circumference of fan 310 as defined by the fan blades 404 when rotating. Further, the heating elements 302, 304 are not required to be ring shaped, but could be linear, block or circular in shape and may be positioned in the front of the hub 802 of the fan 310 such that all or at least part of the heating elements are in alignment with the hub 802 of the fan 310 and extend to the bend of the distal end 406 of the fan blade 404, to the tip 800 of the fan blades 404, or beyond.

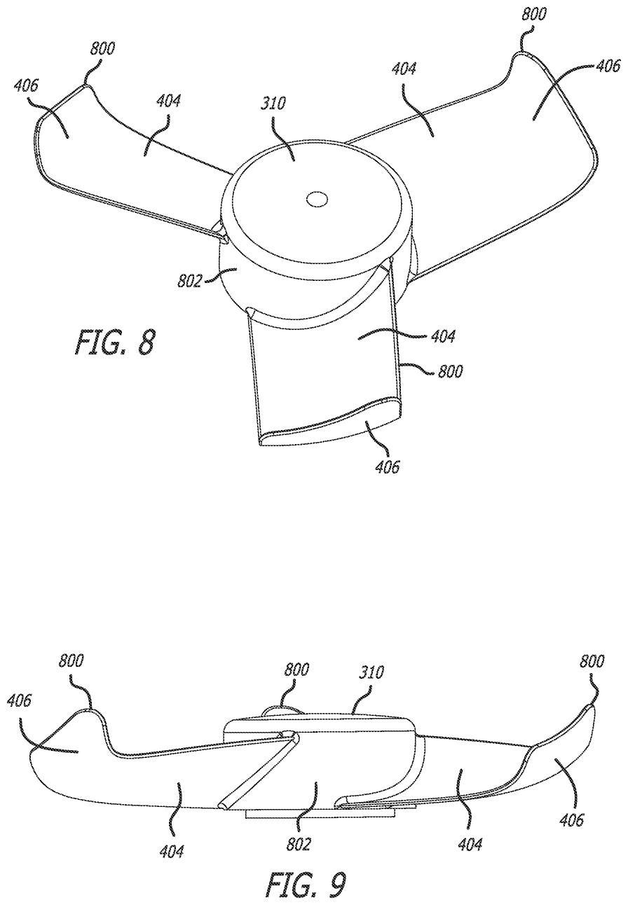

The wing-tip formation of the fan blades 404 is best illustrated in FIGS. 8 and 9. The fan 312 includes a plurality of fan blades 404 connected to a hub 802, which in this example is three fan blades 404; however, those skilled in the art will recognize that the fan 301 can consist of at least two or more blades 404. FIG. 8 shows how the distal end 406 of each fan blade 404 is bent forward towards the front of the fan in the direction of the airflow to create a wingtip 800. FIG. 9 illustrates the fan blades 404 positioned in angular relationship to the rotational axis of the fan 310 along the hub 802.

As illustrated in FIG. 3, the front duct 300 and rear duct 301 are encased within the front housing 102 and rear housing 202. Although in exploded view of FIG. 3 the rear duct 301 is shown exterior to the rear housing 202, during assembly, the rear duct 301 is positioned internally to the rear housing 202. The front duct 300 and rear duct 301 together form a duct assembly 1000, which houses the heating assembly 400 shown in FIGS. 4-7.

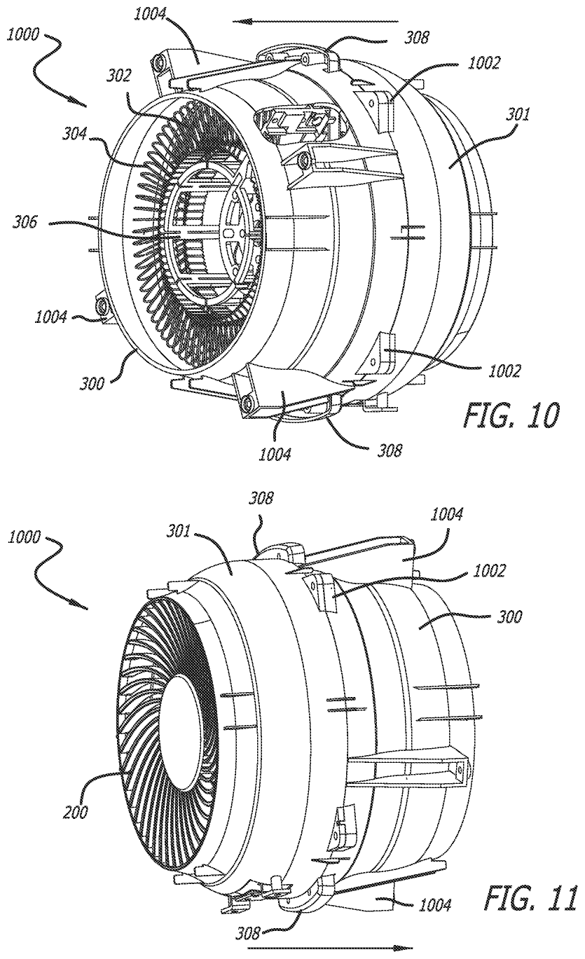

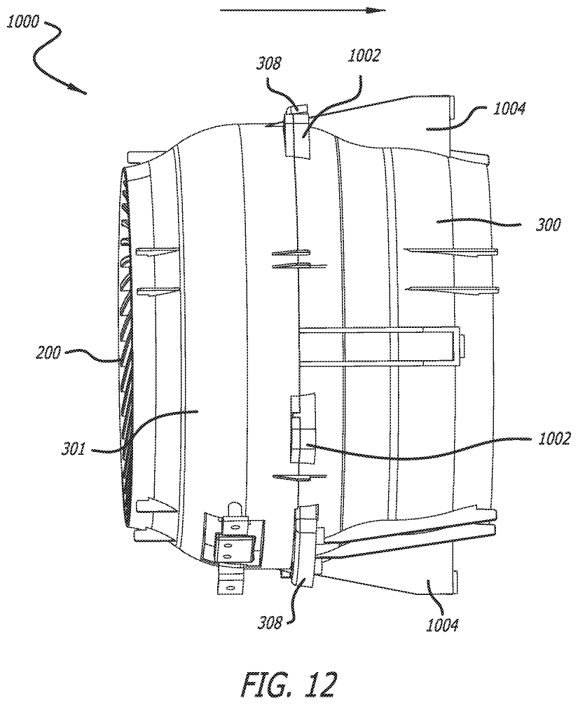

FIG. 10 is a front perspective side view of one example of a duct assembly of portable space heater of FIG. 1. FIG. 11 is a rear perspective side view of the duct assembly, and FIG. 12 is a side view of the duct assembly of FIG. 10.

In FIGS. 10-12, the arrows show the direction of air flow through the duct assembly 1000. Accordingly, the fan 310 pulls air into the portable space heater 100 through the rear grill 200 and then forces the air forward, over and through the first and second heating elements 302, 304 and out the front grill 108. The duct assembly 1000 acts to direct the airflow through the portable space heater 100. The duct assembly 1000 resembles that of an egg shape, being larger in circumference at the intake of air toward the back of the duct assembly 1000 where the air is pulled into the duct assembly 1000 by the fan 310 and being smaller in circumference near the front of the duct assembly 1000 where the air exits the duct assembly 1000, by gradually reducing the circumference of the duct assembly 100 approaching the front grill 108.

By gradually reducing the circumference, the air flowing through the duct assembly 1000, as it moves from back to front, is compressed and thus increases in velocity as it exists the duct assembly 1000. The front duct 300 and back duct 301 are held together by fasteners 1002, and the entire duct assembly 1000 is secured to the housing by mounting members 1004. The mounting bracket 308 is positioned between the front and rear ducts 300, 301 and is fastened to at least one of the front or rear ducts 300, 301. As shown in FIGS. 3, 10 and 12, in this example, the mounting bracket 308 is affixed to the front duct 300. Further fasteners (not shown) can be provided along the exterior of the duct assembly 1000 to secure the duct assembly 1000 to the base 114 or to other areas of the front or rear housing 102, 202.

While one or more heating elements 302, 304 can be used in the heating assembly 400 described above, the use of more than one heating element provides for the capability of producing heat at various settings, for example, at least two settings. In any event, at least one heating element is required. The at least one heating element is not limited to the heating element described in this application. Those skilled in the art will recognize that other heating elements, such as heating coils, ceramic heaters, heating ribbons, PTC heaters or other heaters generally known in the art may be used without departing from the scope of the invention.

In operation, the fan 310 can also be operated separate from the heating elements 302, 304 coils, to enable a fan only option. Further, the heating coils 302, 304 can be operated together or independently to vary heat production and/or may be operated at different levels. For example, a low heat setting may be 750 Watts and a high heat setting may be 1500 Watts.

Further, when used with the duct assembly 1000, it is not required that the heating elements 302, 304 be equal to or lesser than the fan 310 diameter. In some implementations, the heating elements 302, 304 could extend past the end of the fan blades 404.

As set forth above, the heating assembly 400 and duct assembly 1000 can be contained in housings of varying designs, and may include a cool-touch casing, auto shut-off feature, tip-over protection and/or controls for adjusting the heat settings and controlling the fan operation separate from the heating elements.

Optionally, the fan 310 can operate at a single speed, or at various speeds. The heating elements may be a single heating element or may include one or more heating elements to provide further heat settings. Temperature controls may also be provided, along with a temperature sensor to shut off and activate the heater depending upon the room temperature (i.e., to provide an auto climate feature). The heater may also include a timer, a light, a LED display, manual controls, bedtime light dimming features, and/or cord storage. Standard electrical components are also provided, although not shown, to provide electricity to the fan motor and heating elements and to the control the operation of the same.

It will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

We claim:

1. A space heater comprising:
a heater housing having a front grill and rear grill;
a fan positioned near the rear grill of the heater housing;
at least one heating element positioned in front of the fan behind the front grill of the heater housing where the heating element and the fan are linearly aligned; and
a duct assembly positioned within the heater housing surrounding both the fan and the heating element where the duct assembly gradually decreases in circumference as it approaches the front grill of the heater housing.

2. The space heater of claim 1 where the at least one heating element includes at least two ring shaped heating elements.

3. The space heater of claim 2 where the fan includes a hub and fan blades having tips and where the at least two ring shaped heating elements are positioned in front of the fan where the center of the at least two ring shaped heating elements is on the axis of rotation of the fan and are in linear axial alignment with the fan such that the at least two ring shaped heating elements are aligned between the hub of the fan and the tip of the fan blades.

4. The space heater of claim 1 where the fan and the at least one heating element are both in communication with a controller that is programed to operate the fan either with, or independent of, the at least one heating element.

5. A space heater comprising:
a heater housing having a front grill and rear grill; and
a heating assembly including:
a fan having at least two fan blades having fronts and tips; and
at least one circular heating element positioned in front of the fan where the center of the circular heating element is on the axis of rotation of the fan and where the diameter of the circular heating element extends across the fronts of the fan blades not beyond the tips of the fan blades; and where,
the heating assembly is positioned within the heater housing such that the heating element is positioned behind the front grill of the heater housing and the fan is positioned near the rear grill of the heater housing.

6. The space heater of claim 5, further including a duct assembly positioned within the heater housing enclosing the heating assembly where the duct assembly gradually decreases in circumference as it approaches the front grill of the heater housing.

7. The space heater of claim 5 where the fan further includes a hub and where the at least one circular ring shaped heating element is at least two ring shaped heating elements.

8. The space heater of claim 5 where the fan and the at least one circular heating element are both in communication with a controller that is programed to operate the fan either with, or independent of, the at least one circular heating element.

9. The space heater of claim 5 further including a motor having a shaft positioned between the at least one circular heating element and the fan, where the fan is affixed to the shaft of the motor and where the at least one circular heating element is mounted to the motor on the side of the motor opposing the shaft.

10. The space heater of claim 9 where the at least one circular heating element is affixed to a barrel mount, and where the barrel mount is mounted to the motor.

11. A space heater comprising:
a heater housing having a front grill and rear grill; and
a heating assembly including:
a fan having a fan hub and fan blades, where the fan blades have fronts and tips; and
at least one ring shaped heating element positioned in front of the fan where the center of the ring shaped heating element is on the axis of rotation of the fan and where the ring shaped heating element is in linear alignment with the fan such that the at least one ring shaped heating element is positioned between the hub of the fan and the tip of the fan blades; and where,
the heating assembly is positioned within the heater housing such that the heating element is positioned behind the front grill of the heater housing and the fan is positioned near the rear grill of the heater housing.

12. The space heater of claim 11, further including a duct assembly positioned within the heater housing enclosing the heating assembly where the duct assembly gradually decreases in circumference as it approaches the front grill of the heater housing.

13. The space heater of claim 11 where the fan and the at least one ring shaped heating element are both in communication with a controller that is programed to operate the fan either with, or independent of, the at least one ring shaped heating element.

14. The space heater of claim 11 where the at least one right shaped heating element is a heating ribbon.

15. The space heater of claim 14 where the heating ribbon includes ceramic heating elements.

16. The space heater of claim 14 where the heating ribbon includes wire heating elements mounted on the heating ribbon.

17. The space heater of claim 11 where the at least one ring shaped heating element is a wire coil.

18. The space heater of claim 11 where the at least one ring shaped heating elements include at least two ring shaped heating elements.

19. The space heater of claim 11 where the fan includes wing tipped fan blades.
